(19) United States
(12) Patent Application Publication
(10) Pub. No.: US 2005/0103820 A1
(43) Pub. Date: May 19, 2005

(54) Solder ring for production of vacuum tube and method for the production of such a solder ring and of a vacuum tube

(76) Inventor: Johannes Hermannus Laurentius Antonius Hilderink, Haaksbergen (NL)

Correspondence Address: Kirk D Houser;Eckert Seamans Cherin & Mellott, 600 Grant Street, 44th Floor, Pittsburgh, PA, 15219, US

(21) Appl. No.: 10/499,410

(22) PCT Filed: Dec. 23, 2002
(86) PCT No.: PCT/NL02/00865

(30) Foreign Application Priority Data
Dec. 21, 2001 (NL) 1019651

(51) Int. Cl. B23K 35/14

(52) U.S. Cl. 228/56.3

(57) ABSTRACT

Solder ring (12) for joining two components (10, 11) of a vacuum tube, the solder ring (12) comprising a joining part that consists of solder material for forming an airtight joint between the two components. The solder ring (12) further comprises at least one centring part. The centring part has at least one first projection (14, 15) that extends on one side of the joining part essentially in an axial direction of the solder ring (12) and at least one second projection (13, 16) that extends in an opposing direction for centring the two components (10, 11) with respect to one another.

### BACKGROUND OF THE INVENTION

1. Field of the Invention

The invention relates to a solder ring for use in the production of a vacuum tube and a method for the production of such a solder ring. More particularly, the present invention relates to a solder ring according to the preamble of claim 9.

The present invention furthermore relates to a method for the production of a vacuum tube and more particularly to joining the various components for the vacuum tube to one another. Joining of the components to one another is effected with the aid of a hard solder that is placed between the join locations.

2. Background Information

EP-A-0 204 145 describes a connection part for soldering two tubes together. In one specific embodiment (see FIG. 2) the part is a solder ring having two axially extending parts on opposite sides of the part. The radially extending parts are located at the outside edge of the connection part.

A solder ring for use in the production of a vacuum tube is disclosed in German Patent Application DE-OS 39 31 774. This document describes a vacuum tube where a solder ring is placed between the ceramic housing and an end cap for making an airtight joint between them.

For soldering components to one another it is important, especially when fixing end caps to a ceramic housing, that said end caps are fixed properly centered on the housing. If this is not the case there is then a possibility that the distances between live parts are no longer adequate and an electrical discharge can take place between those parts. High mechanical stresses can also be produced, which can result in failure of the ceramic.

In order to hold the components for soldering centered in the correct manner, these are held together with the aid of jigs. The vacuum tube made up in this way is placed in a furnace, after which, successively, the desired vacuum level is achieved with the aid of a vacuum pump and the solder material is made to melt by heating, so that after cooling a vacuum tube with the desired vacuum is obtained. Both the fitting and the subsequent removal of the jigs must be carried out by hand. However, the use of jigs thus means that this method was not only labor intensive, but also that fewer made-up vacuum tubes can be processed simultaneously in the furnace and that, because of the thermal capacity of the jigs, more energy is needed to achieve the desired temperature. Consequently, the final cost price of vacuum tubes produced in such a way is very high.

In addition, the use of jigs means that differences in expansion arise because the jigs expand more than the ceramic of the vacuum tubes. At conventional soldering temperatures this will result in a play of 0.5 to 1 mm. This play is in addition to other tolerances that are customary and thus gives rise to further impairment in the centering of the components.

German Patent Application DE-OS 36 28 174 discloses a method with which the use of jigs is avoided by providing the ceramic housing of the vacuum tubes with an internal centering rim. Although the disadvantages of the method using jigs no longer arise with this procedure, such a centering rim, however, makes the ceramic housing additionally expensive, as a result of which the cost price of the complete vacuum tube is thus also adversely affected.

In order to avoid the use of a centering rim in the ceramic housing, in the cited publication it is further proposed to shape certain components such that the desired centering is achieved by means of these components. However, as a result of the special shaping the production costs for these components becomes higher and this will also increase the cost price of the vacuum tube.

The abovementioned DE-OS 39 31 774 also discloses a solution in which the components are shaped in such a way that the desired centering can be achieved by this means. An additional disadvantage of such solutions is that as a result of the physical contact between the components and the inside of the ceramic housing the field strength is adversely affected, as a result of which the axial dimensions of the vacuum tube also have to be larger. It will also have to be ensured that the frictional forces generated by the centering in the ceramic housing are not so large that these give rise to the problem that the component concerned is held back when the solder melts and is not able to make adequate contact with the other joining surface, as a result of which the joint is not sufficiently strong.

### SUMMARY OF THE INVENTION

The aim of the invention is, now, to provide a solder ring and method for the production of a vacuum tube with which the said disadvantages are avoided and with which a vacuum tube is obtained at an appreciably lower cost price.

To this end, according to the present invention a solder ring of the type defined in the preamble is provided, the solder ring further comprising at least one first projection being on an inside edge of the solder ring and at least one second projection being on an outside edge of the solder ring. The two components of the vacuum tube are, for example, formed by an end cap and a housing. The end cap can be of an electrically conducting material and the housing of a ceramic material.

Using a solder ring of this type it is possible to assemble and solder components of a vacuum tube to be joined without an additional or separate treatment and with this procedure the solder ring also provides for the desired centering of the components. The joining part is shaped and sized in such a way that a joint of adequate mechanical strength between the parts to be joined is obtained by this means and the sole function of the at least one centering part is to enable the parts to be joined to be assembled in a simple but correct manner and to be centered and fixed with respect to one another. By centering the solder rings on the inside of, for example, the housing made of ceramic, these rings will, as a consequence of the unequal expansion, press firmly against the inside of the ceramic during heating. At the soldering temperature employed, a more accurate centering is achieved by this means.

This embodiment is simple to produce from existing solder rings, for example by (partially) bending over the edge of the solder ring or cutting or punching the projections from the edge and then bending these over.

In a further embodiment the at least one first and/or second projection extend over the entire periphery of the solder ring. Such a ring can be produced in a simple manner from a flat solder ring of the correct diameter. In this case the width of the ring is approximately 50% greater than the width that is normally used and the thickness is then approximately 50% less than the thickness normally used. The at least one first and/or second projection can then, for example, be formed by flanging the edge of the solder ring.

A further aspect of the present invention relates to a method for the production of a solder ring according to the present as defined in claim 15. This is, in particular, applicable to already existing solder rings. As a result of forming the projections, the size (external diameter minus internal diameter) has to be chosen larger.

The method for the production of the solder ring can also comprise the step of punching rings of a predetermined internal and external diameter from a strip-shaped piece of solder material. In a further embodiment the punching and shaping can take place at the same time, for example by means for a follower stamp. The upright rims can then be made by flanging. The strip material that remains can be re-used by melting and rolling it out again.

Yet a further aspect of the present invention relates to a method for the production of a vacuum tube, comprising the steps of loosely assembling at least one housing, two end caps and two solder rings according to the present invention, the solder rings being placed between the housing and the two end caps; applying vacuum to the loosely assembled vacuum tube; and heating the loosely assembled vacuum tube to a temperature at which the solder rings melt and respective airtight joints form between the housing and the respective end caps of the vacuum tube, the solder rings providing for centering of the end caps with respect to the housing. Using this method it is possible to produce vacuum tubes in a very inexpensive and efficient manner. Furthermore, accurate and simple centering of the various components with respect to one another is obtained.

### BRIEF DESCRIPTIONS OF THE DRAWINGS

The present invention is explained in more detail below with the aid of a few illustrative embodiments, with reference to the appended drawing.

FIG. 1 shows a partial section of a vacuum tube with the solder ring according to one embodiment of the present invention therein;

FIG. 2 shows a plan view of a solder ring according to a first embodiment of the present invention;

FIG. 3 shows a cross-sectional view of the solder ring along the line III-III in FIG. 2;

FIG. 4 shows a plan view of a solder ring according to a second embodiment of the present invention; and

FIG. 5 shows a partial cross-section of the solder ring of FIG. 4 along the line V-V.

### DESCRIPTION OF THE PREFERRED EMBODIMENTS

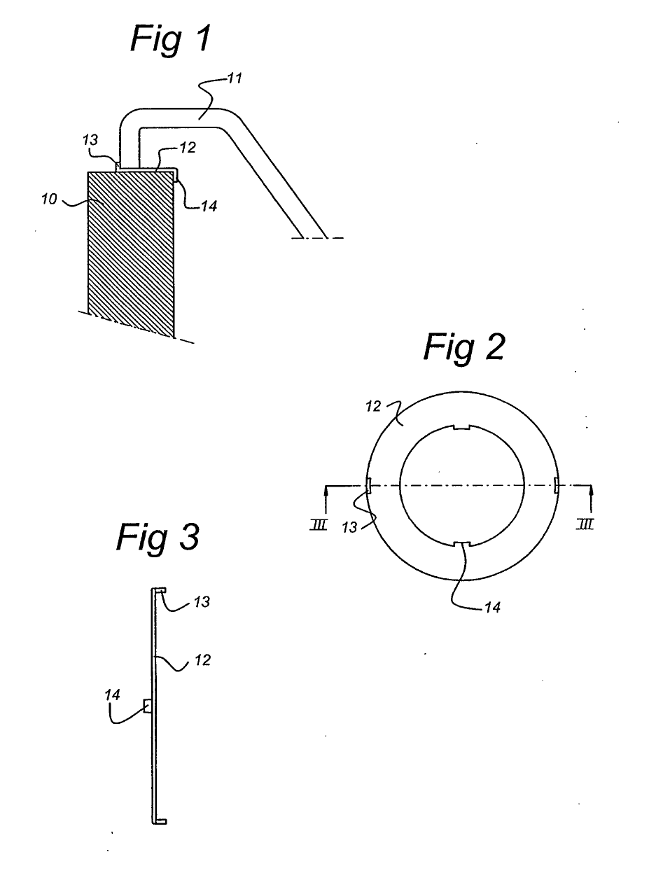

A partial cross-section of an assembly of a housing 10, end cap 11 and solder ring 12, which can be used to produce a vacuum tube, for example for an electrical vacuum switch, is shown in FIG. 1. The vacuum tube is axisymmetrical and in general has two end caps 11, one at each end of the cylindrical housing 10. The housing 10 is frequently made of a ceramic material that has a different coefficient of expansion to the electrically conducting material of the end cap 11. For the vacuum tube to function correctly, the end cap 11 and housing must be centered very accurately with respect to one another. With the embodiment of the solder ring 12 shown this is achieved by a centering section of the solder ring 12 formed by projections 13, 14 on the outside edge and inside edge, respectively, of the solder ring 12.

For production of the vacuum tube, the loosely assembled set of housing 10, end caps 11, solder rings 12 and other components of the vacuum tube are placed in a vacuum, for example a vacuum chamber. The whole is then heated, so that the solder rings 12 melt and form an airtight joint between the housing 10 and the end caps 11. During the heating process the solder ring 12 will press firmly against the inside of the (ceramic) housing 10 as a result of expansion. Accurate centering of the end caps 11 with respect to the housing 10 is obtained as a result.

A first embodiment of a solder ring 12 according to the present invention is shown in FIGS. 2 and 3. In the plan view in FIG. 2 it can be seen that the solder ring 12 has two projections 13 on the outside edge and two further projections 14 on the inside edge. As can be seen in the cross-sectional view in FIG. 3, the projections 13 and the further projections 14 extend in opposing directions, essentially parallel to the axis of the solder ring 12. It will be clear to those skilled in the art that more or differently shaped projections 13, 14 can be present.

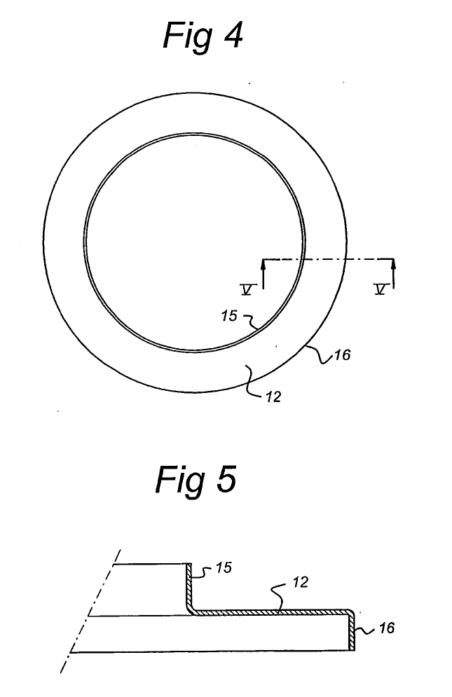

A second embodiment of a solder ring according to the present invention is shown in FIGS. 4 and 5. In this case the centering section of the solder ring 12 is formed by two rims 15, 16 that are formed on the inside and outside, respectively, of the solder ring 12. This can clearly be seen in the partial cross-section in FIG. 5. The rims 15, 16 extend in opposing directions, essentially parallel to the axis of the solder ring 12.

In widely used designs for vacuum switches solder rings 12 with a width of, for example, 11 mm, with an internal diameter of 49.5 mm and an external diameter of 58.5 mm can be used. The rims are, for example, 1.5 mm high. The material of the solder ring 12 is, for example, 0.1 mm thick solder material. In a variant the internal diameter and external diameter are 49.5 mm and 56.5 mm respectively (width 7 mm) or 59.5 mm and 66.5 mm respectively (width again 7 mm).

A vacuum tube can be produced in a very simple and economical manner with the aid of a solder ring 12 according to the present invention. Instead of using jigs to hold the various components (in particular ceramic housing 10, end caps 11 and solder rings 12) centered with respect to one another during the production process, in the present case the whole can be loosely assembled. The loosely assembled set of components is then placed in a vacuum chamber and brought under vacuum. The set of components is then heated to a temperature at which the solder rings 12 melt. During the heating process the ceramic housing 10 and the metal end cap 11 will expand in different ways. As a result of the special shape of the solder rings 12 the various components will be centered and remain centered. After cooling, an airtight joint has been produced between the ceramic housing and the end caps 11, as a result of which a vacuum tube is formed with high accuracy.

The solder rings 12 can be produced in a number of simple ways. For instance, conventional solder rings 12 (with somewhat modified dimensions) can be provided with the projections 13, 14, for example by bending over (parts of) the inside edge and outside edge of the solder ring 12, or by cutting out and then bending over the projections 13, 14.

In addition it is possible to produce the solder rings 12 from a strip of suitable solder material. In a first step, rings of the correct internal and external diameter are then punched from the strip. Subsequently, for example, the upright rims 15, 16 are made by flanging. It is also possible to carry out the process of punching and bending over in one process step, for example with the aid of a follower stamp, by means of which punching and pressing through is carried out at the same time.

The solder material of the strip that remains after processing can be re-used by melting and rolling it out again.

1. Solder ring (12) for joining two components (10, 11) of a vacuum tube, the solder ring (12) comprising a joining part that consists of solder material for forming an airtight joint between the two components, characterised in that
the solder ring (12) further comprises at least one centring part, the centring part having at least one first projection (14; 15) that extends on one side of the joining part essentially in an axial direction of the solder ring (12) and at least one second projection (13; 16) that extends in an opposing direction for centring the two components (10, 11) with respect to one another.

2. Solder ring according to claim 1, wherein the at least one first projection (14; 15) is on an inside edge of the solder ring and the at least one second projection (13; 16) is on an outside edge of the solder ring.

3. Solder ring according to claim 1 or 2, wherein the at least one first and/or second projection (13, 14; 15, 16) extend over the entire periphery of the solder ring (12).

4. Solder ring according to claim 1, 2 or 3, wherein the two components comprise at least an end cap (11) and a housing (10).

5. Solder ring according to claim 1, 2, 3 or 4, wherein the end cap (11) is made of an electrically conducting material and the housing (10) is made of a ceramic material.

6. Method for the production of a solder ring (12) according to one of claims 1 to 5 comprising the steps of
forming the at least one centring part by bending over at least one section (13, 14; 15, 16) of the inside and outside edge of a solder ring (12).

7. Method according to claim 6, comprising the further step of punching rings (12) of a predetermined internal and external diameter from a strip-shaped piece of solder material.

8. Method according to claim 7, wherein punching and shaping take place at the same time by means of a follower stamp.

9. Method for the production of a vacuum tube, comprising the steps of loosely assembling at least one housing (10), two end caps (11) and two solder rings (12) according to one of claims 1 to 5, the solder rings (12) being placed between the housing (10) and the two end caps (11);
applying vacuum to the loosely assembled vacuum tube;
heating the loosely assembled vacuum tube to a temperature at which the solder rings (12) melt and respective airtight joints form between the housing (10) and the respective end caps (11) of the vacuum tube,
the solder rings (12) providing for centring of the end caps (11) with respect to the housing (10).
